(19) United States
(12) Patent Application Publication
(10) Pub. No.: US 2014/0379104 A1
(43) Pub. Date: Dec. 25, 2014

(54) ELECTRONIC DEVICE AND METHOD FOR CONTROLLING BASEBOARD MANAGEMENT CONTROLLERS

(71) Applicants: HONG FU JIN PRECISION INDUSTRY (Shenzhen) CO., LTD., Shenzhen (CN); HON HAI PRECISION INDUSTRY CO., LTD., New Taipei (TW)

(72) Inventors: MING-XIANG HU, Shenzhen (CN); SHUANG PENG, Shenzhen (CN); JI-BAO CHEN, Shenzhen (CN); RUI-PING MA, Shenzhen (CN); SHOU-HENG MA, Shenzhen (CN); HAI-YANG LI, Shenzhen (CN); XIAO-HU YANG, Shenzhen (CN)

(21) Appl. No.: 14/308,887

(22) Filed: Jun. 19, 2014

(30) Foreign Application Priority Data
Jun. 21, 2013 (CN) 2013102505843

(51) Int. Cl. G05B 15/02

(52) U.S. Cl. CPC G05B 15/02
USPC 700/90

(57) ABSTRACT

An electronic device is connected to an Inter-Integrated Circuit (I2C) expander using an I2C controller of the electronic device. The I2C expander is connected to the servers. Each of the servers corresponds to an identification number. Method of controlling baseboard management controller (BMC) of servers using the electronic device includes receiving identification numbers and determining an operation mode corresponding to each of the identification numbers. According to the identification numbers, each of the identification numbers corresponding to a determined server, servers are determined. The electronic device is controlled to connect to the determined servers. A restart server group comprising one or more determined servers whose operation modes are to restart BMC is determined. A restart signal is transmitted to the restart server group. A BMC of each of the one or more determined servers in the restart server group are controlled to restart according to the restart signal.

### FIELD

Embodiments of the present disclosure relate to testing technology, and particularly to an electronic device and a method for controlling baseboard management controllers (BMCs) of servers.

### BACKGROUND

A plurality of servers can be positioned in a rack. Each of the servers has a baseboard management controller (BMC). A rack management controller (RMC) in the rack can control the BMCs of the servers. When testing the BMCs, the RMC has to test each BMC one by one.

### BRIEF DESCRIPTION OF THE DRAWINGS

Implementations of the present technology will now be described, by way of example only, with reference to the attached figures, wherein:

FIG. 1 is a block diagram of one embodiment of an electronic device including a control system.

FIG. 2 is a block diagram of one embodiment of function modules of the control system in the electronic device of FIG. 1.

FIG. 3 illustrates a flowchart of one embodiment of a method for controlling baseboard management controllers in the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

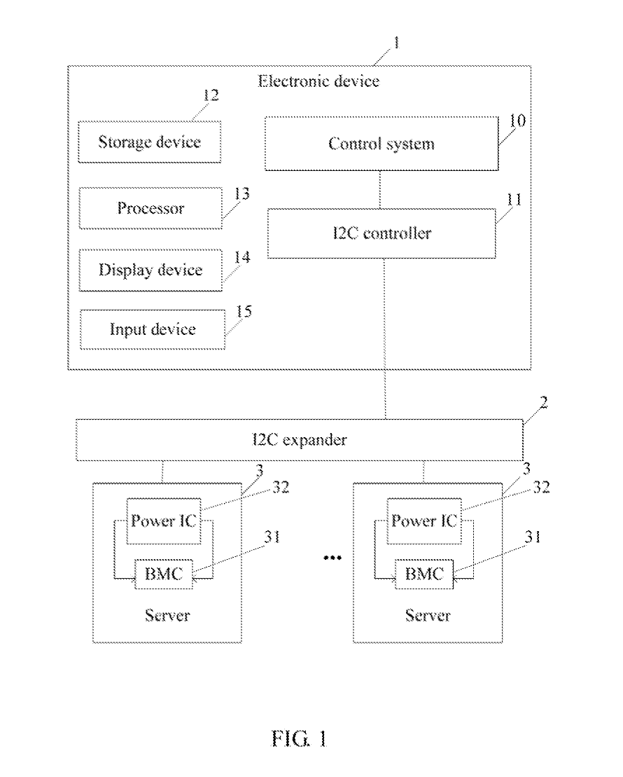

FIG. 1 illustrates a block diagram of one embodiment of an electronic device. Depending on the embodiment, the electronic device 1 includes a control system 10 and an Inter-Integrated Circuit (I2C) controller 11. The electronic device 1 can be in connection to an I2C expander 2 using the I2C controller 11. The I2C expander 11 can be connected to a plurality of servers 3 using general-purpose input/output (GPIO). The I2C expander 2 can have a plurality of ports. Each of the ports corresponds to an identification number. Each of the ports can be connected to a server 3. Therefore, each server 3 corresponds to an identification number of a port that is connected to the server 3. Each server 3 includes a BMC 31 and a power integrated circuit (power IC) 32. The power IC 32 can control the BMC 31.

The electronic device 1 can further include, but is not limited to, a storage device 12, at least one processor 13, a display device 14, and an input device 15. The electronic device 1 can be a computer, a smart phone, a personal digital assistant (PDA), or other suitable electronic device. It should be understood that FIG. 1 illustrates only one example of the electronic device 1 that can include more or fewer components than illustrated, or have a different configuration of the various components in other embodiments.

The control system 10 can control a plurality of servers 3 at a same time.

In at least one embodiment, the storage device 12 can include various types of non-transitory computer-readable storage mediums, such as a hard disk, a compact disc, a digital video disc, or a tape drive. The display device 14 can display images and videos, and the input device 15 can be a mouse, a keyboard, or a touch panel to input computer-readable data.

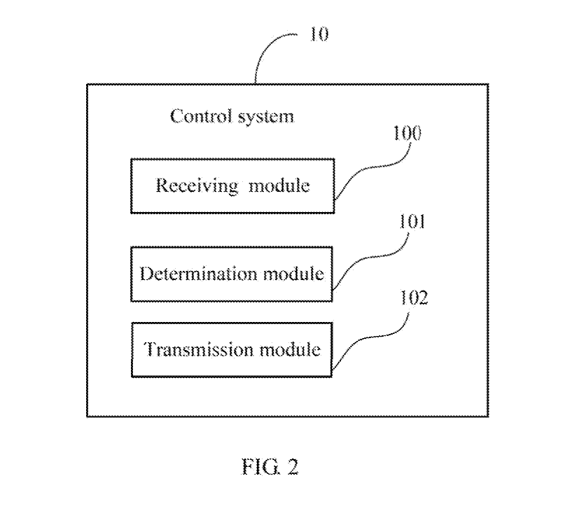

FIG. 2 is a block diagram of one embodiment of function modules of the control system. In at least one embodiment, the control system 10 can include a receiving module 100, a determination module 101, and a transmission module 102. The function modules 100, 101 and 102 can include computerized codes in the form of one or more programs, which are stored in the storage device. The at least one processor 13 executes the computerized codes to provide functions of the function modules 100, 101, 102.

The control system 10 provides a user interface, and a user can input identification numbers through the user interface displayed on the display device 14, and select an operation mode corresponding to each of the identification numbers on the user interface. The receiving module 100 receives identification numbers and the operation mode corresponding to each of the identification numbers through the user interface.

In at least one embodiment, a received operation mode of “0” indicates to restart BMC. A received operation mode of “1” indicates to shutdown BMC or boost BMC.

According to the identification numbers, the determination module 101 determines servers, and controls the electronic device 1 to connect to the determined servers using the I2C expander 2. Each of the identification numbers corresponding to a determined server.

According to the received operation mode corresponding to each of the identification numbers, the determination module 101 determines a restart server group, which includes one or more determined servers whose operation modes are to restart BMC.

The determination module 101 determines current states of BMCs of determined servers not in the restart server group. In at least one embodiment, when a boost signal in a high power level is detected from a BMC of one of determined servers not in the restart server group, the determination module 101 determines that a current state of the determined server is a running state. When the boost signal in a low power level is detected from the BMC of the determined server, the determination module 101 determines that the current state of the determined server is a shutdown state.

In another embodiment, one of the determined servers not in the restart server group transmits a jump of an interrupt signal to the electronic device 1. When the jump changes from a low power level to a high power level, the determination module 101 determines that the current state of the determined server is the running state. When the jump changes from a high power level to a low power level to the electronic device, the determination module 101 determines that the current state of the determined server is the shutdown state.

According to the current states of the BMCs of the determined servers not in the restart server group, the determination module 101 classifies the determined servers not in the restart server group into a running server group and a shutdown server group. BMCs of determined servers in the running server group are in running states. BMCs of determined servers in the shutdown server group are in shutdown states.

The transmission module 102 transmits a restart control signal to the restart server group and controls a BMC of each of the one or more determined servers in the restart server group to restart according to the restart control signal. In at least one embodiment, the transmission module 102 transmits the restart control signal to the restart server group using the I2C expander 2. According to the restart control signal, each power IC 32 of the one or more determined servers in the restart server group is controlled to transmit a restart signal to a BMC 31 corresponding to each power IC 32. The BMC 31 corresponding to each power IC 32 is controlled to restart according to the restart signal.

In another embodiment, the transmission module 102 transmits a shutdown control signal to the running server group and controls a BMC of each of the determined servers in the running server group to shutdown according to the shutdown control signal. The transmission module 102 can transmit the shutdown control signal to the running server group using the I2C expander 2. According to the shutdown control signal, each power IC 32 of the determined servers in the running server group is controlled to transmit a shutdown signal to a BMC 31 corresponding to each power IC 32. The BMC 31 corresponding to each power IC 32 is controlled to shutdown according to the shutdown signal.

In other embodiments, the transmission module 102 transmits a boost control signal to the shutdown server group and controls a BMC of each of the determined servers in the shutdown server group to boost according to the boost control signal. The transmission module 102 can transmit the boost control signal to the shutdown server group using the I2C expander 2. According to the boost control signal, each power IC 32 of the determined servers in the shutdown server group is controlled to transmit a boost signal to a BMC 31 corresponding to each power IC 32. The BMC 31 corresponding to each power IC 32 is controlled to boost according to the shutdown signal.

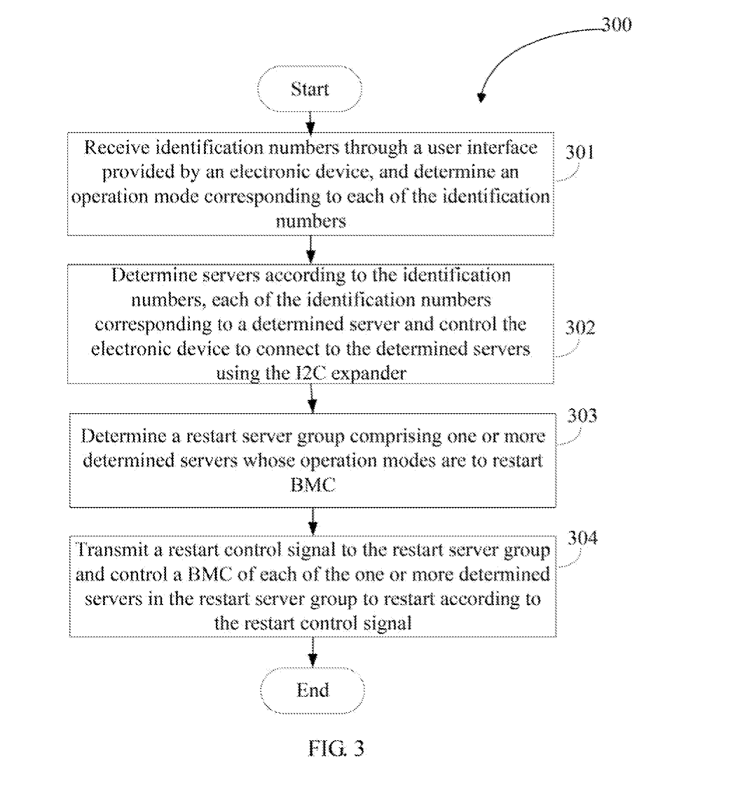

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301. Depending on the embodiment, additional blocks can be added, others removed, and the ordering of the blocks can be changed.

In block 301, a control system provides a user interface, and a user can input identification numbers through the a user interface displayed on a display device of an electronic device, and selects an operation mode corresponding to each of the identification numbers on the user interface. A receiving module receives identification numbers and the operation mode corresponding to each of the identification numbers through the user interface.

The electronic device includes a control system and an Inter-Integrated Circuit (I2C) controller. The electronic device can be in connection to an I2C expander using the I2C controller. The I2C expander can be connected to servers using general-purpose input/output (GPIO). The I2C expander has a plurality of ports. Each of the ports corresponds to an identification number. Each of the ports can be connected to a server. Therefore, each server can corresponds to an identification number of a port that is connected to the server 3. Each server includes a BMC and a power integrated circuit (power IC). The power IC can control the BMC.

In at least one embodiment, a received operation mode of “0” indicates to restart BMC. A received operation mode of “1” indicates to shutdown BMC or boost BMC.

In block 302, according to the identification numbers, a determination module determines servers, and controls the electronic device to connect to the determined servers using the I2C expander. Each of the identification numbers corresponds to a determined server.

In block 303, according to the received operation mode corresponding to each of the identification numbers, the determination module determines a restart server group which includes one or more determined servers whose operation modes are to restart BMC.

The determination module detects current states of BMCs of determined servers that are not in the restart server group. In at least one embodiment, when a boost signal in a high power level is detected from a BMC of one of determined servers not in the restart server group, the determination module determines that a current state of the determined server is a running state. When the boost signal in a low power level is detected from the BMC of the determined server, the determination module determines that the current state of the determined server is a shutdown state.

In another embodiment, one of the determined servers not in the restart server group transmits a jump of an interrupt signal to the electronic device. When the jump changes from a low power level to a high power level, the determination module determines that the current state of the determined server is the running state. When the jump changes from a high power level to a low power level to the electronic device, the determination module determines the current state of the determined server is the shutdown state.

According to the current states of the BMCs of the determined servers not in the restart server group, the determination module classifies the determined servers not in the restart server group into a running server group and a shutdown server group. BMCs of determined servers in the running server group are in running states. BMCs of determined servers in the shutdown server group are in shutdown states.

In block 304, a transmission module transmits a restart control signal to the restart server group and controls a BMC of each of the one or more determined servers in the restart server group to restart according to the restart control signal. In one embodiment, the transmission module can transmit the restart control signal to the restart server group using the I2C expander. According to the restart control signal, each power IC of the one or more determined servers in the restart server group is controlled to transmit a restart signal to a BMC corresponding to each power IC. The BMC corresponding to each power IC is controlled to restart according to the restart signal.

In other embodiments, the transmission module transmits a shutdown control signal to the running server group and controls a BMC of each of the determined servers in the running server group to shutdown according to the shutdown control signal. The transmission module can transmit the shutdown control signal to the running server group using the I2C expander. According to the shutdown control signal, each power IC of the determined servers in the running server group is controlled to transmit a shutdown signal to a BMC corresponding to each power IC. The BMC corresponding to each power IC is controlled to shutdown according to the shutdown signal.

In other embodiments, the transmission module transmits a boost control signal to the shutdown server group and controls a BMC of each of the determined servers in the shutdown server group to boost according to the boost control signal. The transmission module can transmit the boost control signal to the shutdown server group using the I2C expander. According to the boost control signal, each power IC of the determined servers in the shutdown server group is controlled to transmit a boost signal to a BMC corresponding to each power IC. The BMC corresponding to each power IC is controlled to boost according to the shutdown signal.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for controlling baseboard management controller (BMC) of servers using an electronic device, the electronic device being in connection to an Inter-Integrated Circuit (I2C) expander using an I2C controller of the electronic device, the I2C expander being connected to the servers using general-purpose input/output (GPIO), each of the servers corresponding to an identification number, the method comprising:
receiving identification numbers through a user interface provided by the electronic device;
determining an operation mode corresponding to each of the identification numbers;
determining servers according to the identification numbers, each of the identification numbers corresponding to a determined server;
controlling the electronic device to connect to the determined servers using the I2C expander;
determining a restart server group comprising one or more determined servers whose operation modes are to restart BMC; and
transmitting a restart control signal to the restart server group and controlling a BMC of each of the one or more determined servers in the restart server group to restart according to the restart control signal.

2. The method according to claim 1, further comprising:
detecting current states of BMCs of determined servers not in the restart server group; and
classifying the determined servers not in the restart server group into a running server group, BMCs of determined servers in the running server group being in running states; or
classifying the determined servers not in the restart server group into a shutdown server group, BMCs of determined servers in the shutdown server group being in shutdown states.

3. The method according to claim 2, further comprising:
transmitting a shutdown control signal to the running server group and controlling a BMC of each of the determined servers in the running server group to shutdown according to the shutdown control signal.

4. The method according to claim 2, further comprising:
transmitting a boost control signal to the shutdown server group and controlling a BMC of each of the determined servers in the shutdown server group to boost according to the boost control signal.

5. The method according to claim 1, wherein a BMC of one of the determined servers not in the restart server group is determined to be in the running state when a boost signal in a high power level is detected from the BMC of the determined server, or determined to be in the shutdown state when the boost signal in a low power level is detected from the BMC of the determined server.

6. The method according to claim 1, under the condition that one of the determined servers not in the restart server group transmits a jump of an interrupt signal to the electronic device, wherein a BMC of the determined server is determined to be in the running state when the jump of the interrupt signal changes from a low power level to a high power level, or determined to be in the shutdown state when the jump of the interrupt signal changes from a high power level to a low level.

7. An electronic device, the electronic device being in connection to an Inter-Integrated Circuit (I2C) expander using an I2C controller of the electronic device, the I2C expander being connected to servers using general-purpose input/output (GPIO), each of the servers corresponding to an identification number, the electronic device comprising:
at least one processor; and
a storage device that stores one or more programs, which when executed by the at least one processor, cause the at least one processor to:
receive identification numbers through a user interface provided by the electronic device, and determine an operation mode corresponding to each of the identification numbers;
determine servers according to the identification numbers, each of the identification numbers corresponding to a determined server;
control the electronic device to connect to the determined servers using the I2C expander;
determine a restart server group comprising one or more determined servers whose operation modes are to restart BMC; and
transmit a restart control signal to the restart server group and control a BMC of each of the one or more determined servers in the restart server group to restart according to the restart control signal.

8. The electronic device according to claim 7, wherein the at least one processor further detects current states of BMCs of determined servers not in the restart server group; and
classifies the determined servers not in the restart server group into a running server group, BMCs of determined servers in the running server group being in running states; or
classifies the determined servers not in the restart server group into a shutdown server group, BMCs of determined servers in the shutdown server group being in shutdown states.

9. The electronic device according to claim 8, wherein the at least one processor further transmits a shutdown control signal to the running server group and controls a BMC of each of the determined servers in the running server group to shutdown according to the shutdown control signal.

10. The electronic device according to claim 8, wherein the at least one processor further transmits a boost control signal to the shutdown server group and controls a BMC of each of the determined servers in the shutdown server group to boost according to the boost control signal.

11. The electronic device according to claim 7, wherein a BMC of one of the determined servers not in the restart server group is determined to be in the running state when a boost signal in a high power level is detected from the BMC of the determined server, or determined to be in the shutdown state when the boost signal in a low power level is detected from the BMC of the determined server.

12. The electronic device according to claim 7, under the condition that one of the determined servers not in the restart server group transmits a jump of an interrupt signal to the electronic device, wherein a BMC of the determined server is determined to be in the running state when the jump of the interrupt signal changes from a low power level to a high power level, or determined to be in the shutdown state when the jump of the interrupt signal changes from a high power level to a low level.

13. A non-transitory storage medium having stored thereon instructions that, when executed by a processor of an electronic device, the electronic device being in connection to an Inter-Integrated Circuit (I2C) expander using an I2C controller of the electronic device, the I2C expander being connected to the servers using general-purpose input/output (GPIO), each of the servers corresponding to an identification number, wherein the method comprises:
receiving identification numbers through a user interface provided by the electronic device, and determining an operation mode corresponding to each of the identification numbers;
determining servers according to the identification numbers, each of the identification numbers corresponding to a determined server;
controlling the electronic device to connect to the determined servers using the I2C expander;
determining a restart server group comprising one or more determined servers whose operation modes are to restart BMC; and
transmitting a restart control signal to the restart server group and controlling a BMC of each of the one or more determined servers in the restart server group to restart according to the restart control signal.

14. The non-transitory storage medium according to claim 13, wherein the method further comprises detecting current states of BMCs of determined servers not in the restart server group; and
classifying the determined servers not in the restart server group into a running server group, BMCs of determined servers in the running server group being in running states; or
classifying the determined servers not in the restart server group into a shutdown server group, BMCs of determined servers in the shutdown server group being in shutdown states.

15. The non-transitory storage medium according to claim 14, wherein the method further comprises transmitting a shutdown control signal to the running server group and controlling a BMC of each of the determined servers in the running server group to shutdown according to the shutdown control signal.

16. The non-transitory storage medium according to claim 14, the method further comprises transmitting a boost control signal to the shutdown server group and controlling a BMC of each of the determined servers in the shutdown server group to boost according to the boost control signal.

17. The non-transitory storage medium according to claim 13, wherein a BMC of one of the determined servers not in the restart server group is determined to be in the running state when a boost signal in a high power level is detected from the BMC of the determined server, or determined to be in the shutdown state when the boost signal in a low power level is detected from the BMC of the determined server.

18. The non-transitory storage medium according to claim 13, under the condition that one of the determined servers not in the restart server group transmits a jump of an interrupt signal to the electronic device, wherein a BMC of the determined server is determined to be in the running state when the jump of the interrupt signal changes from a low power level to a high power level, or determined to be in the shutdown state when the jump of the interrupt signal changes from a high power level to a low level.
